(19) United States
(12) Patent Application Publication
(10) Pub. No.: US 2017/0225972 A1
(43) Pub. Date: Aug. 10, 2017

(54) COLD WATER DISPENSER WITH ULTRAVIOLET DISINFECTION

(71) Applicant: LVD Acquisition, LLC, Columbus, OH (US)

(72) Inventors: Stephen John SABIN, Ballina (IE); John Francis KENNEDY, Tubbercurry (IE)

(21) Appl. No.: 15/502,032

(22) PCT Filed: Jul. 30, 2015
(86) PCT No.: PCT/US2015/042921

§ 371 Date: Feb. 6, 2017

Related U.S. Application Data
(60) Provisional application No. 62/033,804, filed on Aug. 6, 2014.

(51) Int. Cl. C02F 1/32; B67D 1/08

(52) U.S. Cl. CPC C02F 1/325; B67D 1/0857; C02F 2303/04; C02F 2307/10; C02F 2201/007; C02F 2201/005; C02F 2201/326

(57) ABSTRACT

A device (10) for dispensing cold water has a modular disinfection system (100) that maintains the water near a dispensing spout (40) in a disinfected condition. The modular disinfection system has an ultraviolet (UV) radiation generator, a fluid entrance (104), a fluid exit (106) and a UV-transparent tube (108) that connects the fluid entrance to the fluid exit and maintains the next water to be dispensed. A housing (70) receives the modular disinfection system with the fluid entrance is vertically above the fluid exit. A control means (80) operates both the UV radiation generator and a valve means that allows water to be dispensed through the dispensing spout.

### TECHNICAL FIELD

The disclosed embodiments relate to a device for establishing and maintaining a supply of cold water, as well as dispensing the cold water upon demand from a spout portion adapted for ultraviolet (“UV”) disinfection during the dispensing.

### BACKGROUND

Ultraviolet radiation can be effectively used as a means for a final disinfection of water being dispensed from a water source.

In order to be fully effective, the ultraviolet radiation source must act upon the water up to and including the point at which the water actually exits the spout. A portion of water residing just inside the spout can be exposed to contamination if this does not happen.

The amount of time for the UV source to reach an effective power level after being energized will vary, depending upon the specifics of the UV source used. A consequence of this is that many water dispensing units will keep the UV source energized. While this maintains the disinfection level of the water, it also raises the temperature of the water in the disinfection zone. This is an undesired effect, particularly when the first portion of water being dispensed from a water cooler is actually warmer than ambient. One way to minimize this effect is to limit the volume of water in the disinfection zone when no flow is occurring. However, there are also normal flow rates expected by consumers when using the dispenser. If the volume of water subject to disinfection at any point is being minimized, then the residence time in the disinfection zone is also very low, reducing the effect of the UV radiation.

In one known solution, disclosed in commonly-owned published application WO 2013/126692 A1, a spout is disclosed in which the water makes two passes through a disinfection zone in which the water is exposed to ultraviolet light.

It is therefore an unmet advantage of the prior art to provide a spout for a water dispensing unit that extends the UV radiation as close to the tip of the spout as possible, minimizes the amount of water dispensed at a temperature above ambient, and provides the needed residence time to disinfect, while maintaining an acceptably high flow rate.

### SUMMARY

This and other unmet advantages are provided by a device that dispenses cold water. The device uses a modular disinfection system having an ultraviolet (UV) radiation generator, a fluid entrance, a fluid exit and a UV-transparent tube that connects fluid entrance to the fluid exit.

The cold water dispenser has a housing that is configured to receive the modular disinfection system such that the fluid entrance is vertically above the fluid exit. A reservoir, sized and adapted to contain the water to be dispensed, is located inside the device. A dispensing header is connected to the fluid entrance. It comprises a valve assembly that controls fluid flow into the fluid entrance. At the other end of the modular disinfection system, a dispensing spout is connected to the fluid exit. A conduit connects the reservoir to the dispensing header so that water can be supplied to the modular disinfection system. The valve assembly and the UV radiation generator are both under the control of a controller.

In some embodiments, the device also has a second reservoir that is sized and adapted to heat and contain a supply of water. An inlet conduit of the second reservoir allows this water to be replenished. A spout, separate from the cold water dispensing spout, is connected by an outlet conduit of the second reservoir. In doing this, the hot water does not pass through the modular disinfection system.

In some embodiments, the valve assembly comprises a solenoid that coordinates operation of a valve with operation of the UV radiation generator.

The dispensing header will typically comprise an inlet fitting, an outlet fitting and a solenoid fitting, with the valve received in the solenoid fitting. Movement of the valve relative to the outlet fitting controls fluid flow from the conduit into the UV transparent tube.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is a side sectional view of a portion of the device, providing details of the cold water disinfection portion;

FIG. 2 is a side sectional view of the overall water-dispensing device;

FIG. 3 is a front perspective view of the assembled water-dispensing device;

FIG. 4 is a front perspective view of the water-dispensing device, with a cover removed to disclose internal details; and

FIG. 5. is a plan view of a control panel for the water-dispensing device.

### DETAILED DESCRIPTION

Some general concepts can be discussed before covering specific embodiments. When UV disinfection is used in a water dispenser, it is common to conduct the process on a linear portion of the water flow path. In one type of system, not generally covered here, the UV radiation is generated in a central portion of the flow path, with the water flowing in an annular path that is radially outward from the UV source. In the second type of system, the water flow tube is the central feature and the UV radiation is arrayed circumferentially around the water flow tube, so that the UV radiation is directed radially inward, that is, in the opposite direction of the first type of system.

The inventive concept here is intended to implement a water disinfection unit produced commercially by Philips Specialty Lighting and sold under the trademark INSTANTTRUST. As understood, the proprietary water disinfection unit features a proprietary UV bulb that does not contain any mercury. The bulb also features a rapid “warm up” period for it to reach the effective power level that is discussed in the background section. Rapid warm up is essential in dispensing cold water, so that the initial portion of water dispensed can be maintained in a cooled condition. It is also important to have no significant time delay between when a user presses an activation button and when the dispensing process begins. As also understood by the inventors, the proprietary water disinfection unit has the ability to produce periodic “bursts” of UV radiation to maintain the purity of the water in the proprietary water disinfection unit.

As understood by the inventors, the Philips INSTANTTRUST water disinfection unit provides an enclosed housing, with an inlet and outlet fittings to receive and discharge the water. A straight tube, comprising a UV-transparent material, connects the respective fittings. While internal details of the UV system are not fully understood, the UV radiation is provided by one or more of the proprietary UV bulb and possibly reflective surfaces of a proprietary configuration, so that the tube is surrounded by the UV radiation when the bulb(s) are energized. Electrical leads to provide energy to the UV bulb(s) are arranged on the exterior of the enclosed housing.

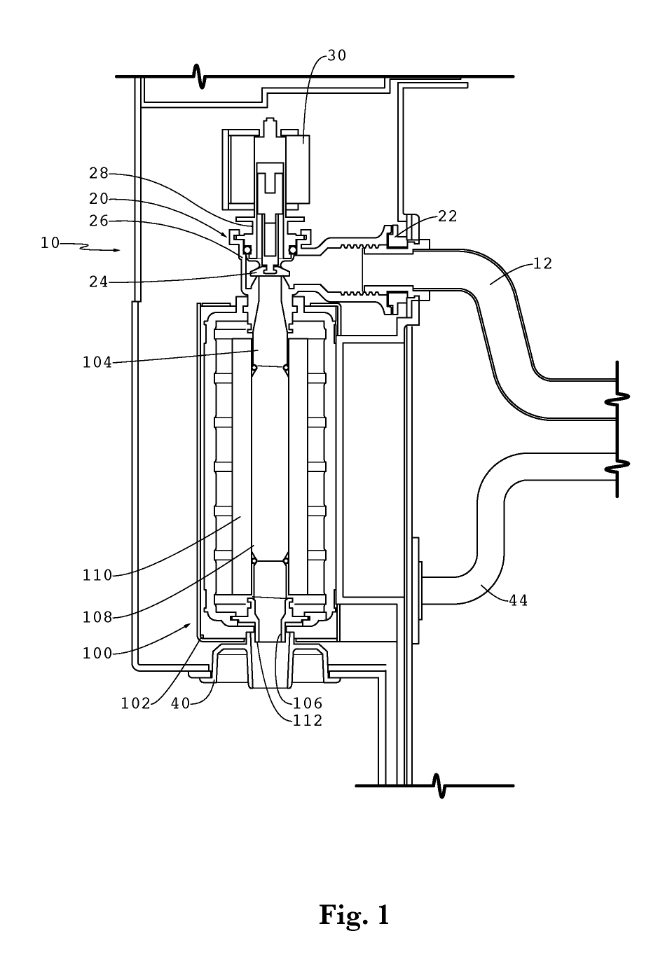

FIG. 1 shows a schematic side sectional view of a portion of a water dispenser 10 that incorporates the proprietary disinfection system 100, which comprises a housing 102, a fluid entrance 104, a fluid exit 106, a UV-transparent tube 108 that provides a liquid communication between the fluid entrance and exit, and a chamber interior 110, which contains a UV radiation and reflection arrangement. In an operative condition, the tube 108 is arranged vertically, the fluid exit 106 being directly below the fluid entrance 104. Not specifically shown in FIG. 1 is a means for providing electrical energy to the UV radiation and reflection means, the means for providing the electrical energy arranged on the exterior of the housing 102. It is anticipated, due to the proprietary nature of the disinfection system, that the water dispenser 10 is constructed to allow for the insertion and removal of the disinfection system 100 in a modular manner.

Beyond the proprietary disinfection system 100, other important features of the water dispenser 10 are shown in FIG. 1. Particularly, a conduit 12 provides cooled water from a chilled reservoir (not shown in FIG. 1). Conduit 12 delivers the chilled water into a dispensing header 20 through an inlet fitting 22. As seen in FIG. 1, conduit 12 is arranged essentially horizontally. Also in the dispensing header 20, but arranged vertically, are an outlet fitting 24 and a solenoid fitting 26, which is adapted for removably receiving a valve 28, driven by a solenoid 30. As is also seen, outlet fitting 24 connects into fluid entrance 104. Starting and stopping fluid flow from the dispensing header 20 into the disinfection unit 100 is regulated by movement of valve 28 away from and into engagement with outlet fitting 24. Not shown in FIG. 1 are the required electrical connections for operating the solenoid 30.

At the opposite end of the disinfection system 100 is a spout fitting 40. In a preferred embodiment, the spout fitting 40 surrounds, but does not directly contact, a discharge point 112 of the fluid exit 106. By being arranged in this manner, the spout fitting 40 shields the discharge point 112, and the water contained there from contamination from hands, cups and the like.

Valve 28 is arranged to close during flow in a manner that allows a column of water to be maintained in the tube 108. To maintain the disinfection of this water, the UV radiation bulbs(s) are energized periodically. In many instances, a burst of the UV bulbs lasting, for example, 100 msec every 10 minutes is believed to be sufficient.

Separately shown in FIG. 1 is a hot water conduit 44, which dispenses hot water when the water dispenser 10 also comprises a hot water dispenser portion as a combined water dispensing unit, which is preferred.

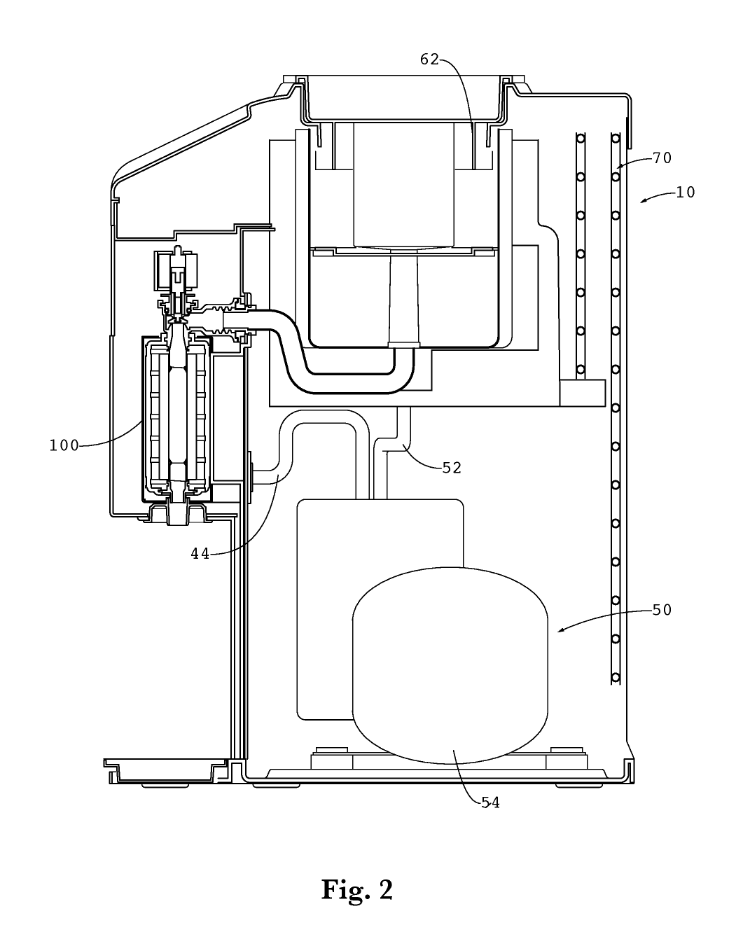

FIG. 2 shows such a water dispenser 10, in which a hot water dispenser portion 50 is included. Typically, a water dispenser 10 would be sized for placement on a counter top. It would also be wired to operate on standard household electrical current, which can vary by country of the intended use.

The hot water dispenser portion 50 comprises a water inlet conduit 52, a reservoir 54 arranged to receive and heat the water, and the hot water conduit 44, which leads to a hot water dispensing spout (not visible in FIG. 2).

Some further details are shown in FIG. 2. In particular, it is noted that there is very little pressure head provided for gravity flow of the water in conduit 12 out of a water chiller 62. The positioning allows for a siphon effect. The combined hot and cold water dispensing portions are preferably housed in a housing 70.

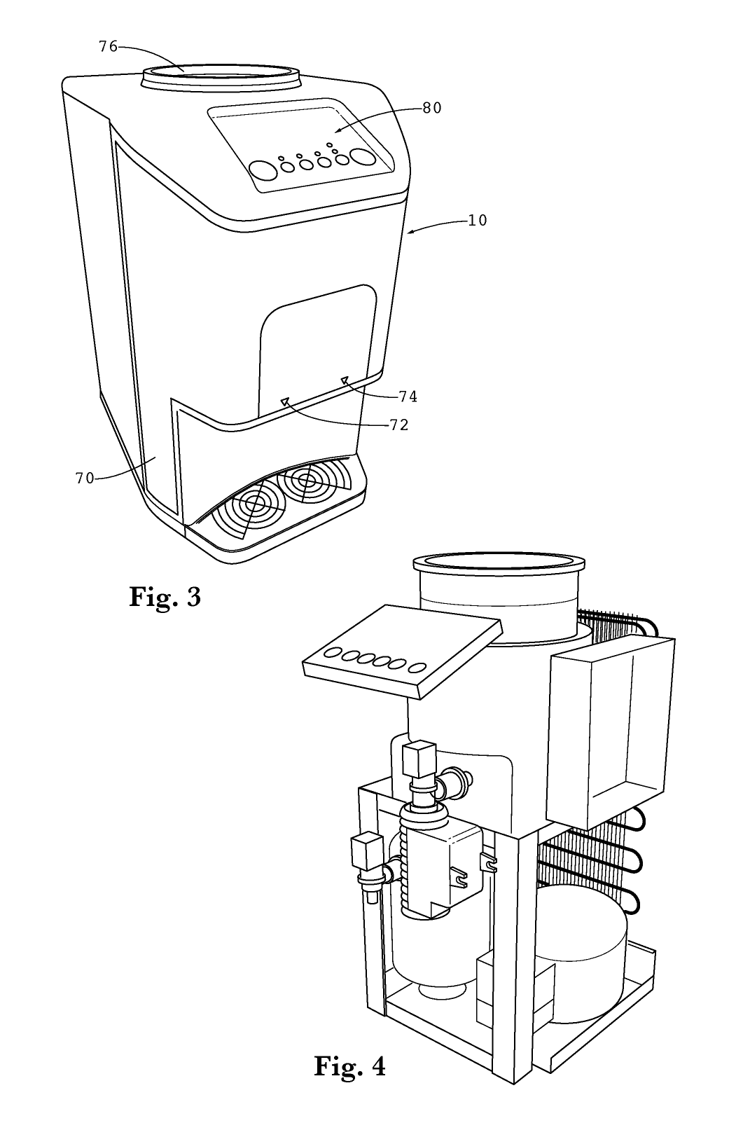

FIG. 3 shows, in front perspective view, an exemplary embodiment of a combined cold and hot water dispensing unit 10, with housing 70 and showing a hot water dispensing area 72, located to the left of the cold water dispensing area 74. A control panel 80 allows a user to control operation of the water dispensing unit 10. A fill aperture 76 is shown in an open condition on top of the housing 70.

FIG. 4 shows the FIG. 3 embodiment with the housing removed, providing a view of internal components.

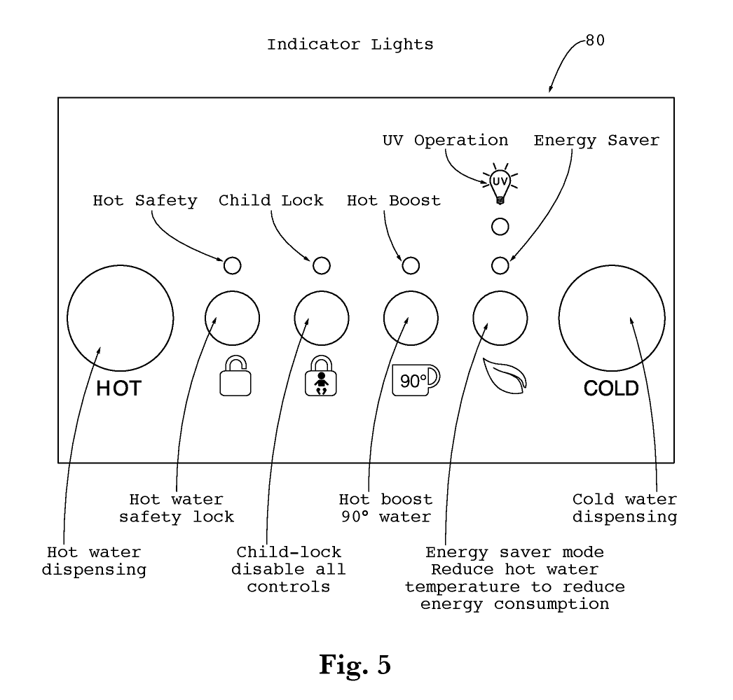

FIG. 5 shows a typical arrangement of control panel 80.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

1. A device for dispensing cold water, the device having a modular disinfection system with an ultraviolet (UV) radiation generator, a fluid entrance, a fluid exit and a UV-transparent tube connecting the fluid entrance to the fluid exit, the device comprising:
a housing, configured to receive the modular disinfection system such that the fluid entrance is vertically above the fluid exit;
a reservoir, sized and adapted to contain the water to be dispensed;
a dispensing header, connected to the fluid entrance and comprising valve means for controlling fluid flow into the fluid entrance;
a dispensing spout, connected to the fluid exit;
a conduit, connecting the reservoir to the dispensing header; and
control means, configured to operate both the UV radiation generator and the valve means, such that water in the UV transparent tube is disinfected before being dispensed through the dispensing spout.

2. The device of claim 1, further comprising:
a second reservoir, located in the housing, sized and adapted to heat and contain a supply of water;
an inlet conduit to replenish the water supply in the second reservoir; a hot water dispensing spout; and
an outlet conduit to communicate the second reservoir to the hot water dispensing spout, without passage through the modular disinfection system.

3. The device of claim 1, wherein:
the valve means comprises a solenoid that coordinates operation of a valve with operation of the UV radiation generator.

4. The device of claim 3, wherein:
the dispensing header further comprises an inlet fitting, an outlet fitting and a solenoid fitting, with the valve received in the solenoid fitting, such that movement of the valve relative to the outlet fitting controls fluid flow from the conduit into the UV transparent tube.

5. The device of claim 2, wherein:
the valve means comprises a solenoid that coordinates operation of a valve with operation of the UV radiation generator.

6. The device of claim 5, wherein:
the dispensing header further comprises an inlet fitting, an outlet fitting and a solenoid fitting, with the valve received in the solenoid fitting, such that movement of the valve relative to the outlet fitting controls fluid flow from the conduit into the UV transparent tube.

7. A method of dispensing cold water, comprising the steps of:
providing a water dispensing device having a modular disinfection system installed in a housing of the device between a reservoir that contains water to be dispensed and a spout through which the water is dispensed, the modular disinfection system comprising an ultraviolet (UV) radiation generator, a fluid entrance, a fluid exit and a UV-transparent tube that connects the fluid entrance to the fluid exit;
selectively operating a valve means at the fluid entrance of the modular disinfection system to hold a portion of the water to be dispensed in the UV transparent tube at all times;
using a control means of the device to operate both the UV radiation generator and the valve means, such that:
when the valve means is open and water is flowing through the UV transparent tube from the fluid entrance to the fluid exit, the UV radiation generator is continuously operated; and
when the valve means is closed and water is not flowing through the UV transparent tube from the fluid entrance to the fluid exit, the UV radiation generator is operated in bursts to maintain a level of disinfection of the water in the UV transparent tube.

8. The method of claim 7, wherein:
the bursts of operation of the UV radiation generator occur on a regular periodic schedule.

9. The method of claim 7, wherein:
each burst of operation of the UV radiation generator lasts approximately 0.1 sec.

10. The method of claim 8, wherein:
each burst of operation of the UV radiation generator lasts approximately 0.1 sec.

11. The method of claim 10, wherein:
a burst of operation of the UV radiation generator occurs after every period of ten minutes of closure of the valve means.
